(19) United States
(12) Patent Application Publication
(10) Pub. No.: US 2026/0046160 A1
(43) Pub. Date: Feb. 12, 2026

(54) SHARING MEDIA ITEMS IN A VIRTUAL MEETING

(71) Applicant: Google LLC, Mountain View, CA (US)

(72) Inventor: Stefan Lindmark, Östhammar (SE)

(21) Appl. No.: 18/797,421

(22) Filed: Aug. 7, 2024

(51) Int. Cl. H04L 12/18; G06F 3/14; H04L 65/1089; H04L 65/613

(52) U.S. Cl. CPC H04L 12/1831; G06F 3/1454; H04L 65/1089; H04L 65/613

(57) ABSTRACT

A method includes providing a virtual meeting user interface (UI) including multiple regions each presenting a visual item corresponding to a video stream generated by one of a plurality of client devices of a plurality of participants of a virtual meeting. The method includes receiving a first request from a first participant of the multiple participants of the virtual meeting to share a first media item with other participants of the virtual meeting. The method includes identifying, in the virtual meeting UI, a first region presenting a visual item corresponding to a video stream generated by a first client device of the first participant. The method includes causing the first media item to be presented within the first region of virtual meeting UI.

### TECHNICAL FIELD

Aspects and implementations of the present disclosure relate to virtual meetings and more specifically to sharing media items in a virtual meeting.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method including providing a virtual meeting user interface (UI) including multiple regions each presenting a visual item corresponding to a video stream generated by one of multiple client devices of multiple participants of a virtual meeting. The method includes receiving a first request from a first participant of the multiple participants of the virtual meeting to share a first media item with other participants of the virtual meeting. The method includes identifying, in a virtual meeting UI, a first region presenting a visual item corresponding to a video stream generated by a first client device of the first participant. The method includes causing the first media item to be presented within the first region of the virtual meeting UI.

In an aspect, the first request to share the first media item is received in response to detecting a user input corresponding to the first participant moving the first media item from a first position that is outside of the virtual meeting UI to a second position within the virtual meeting UI. In an aspect, the method includes providing, for presentation within the first region of the virtual meeting UI, a UI indicator indicating that the first media item displayed within the first region of the virtual meeting UI is shared media content associated with the first participant. In an aspect, first media item includes a video item, and the method further includes providing, for presentation within the first region of the virtual meeting UI, one or more playback controls usable to interact with the video item.

In an aspect, the method includes receiving a second request from the first participant to share a second media item with the other participants of the virtual meeting. The method includes providing, for presentation within the first region of virtual meeting UI, a second media item in place of the first media item. The method includes providing one or more UI elements for display within the virtual meeting UI. The one or more UI elements are useable by the first participant to switch between displaying the first and the second media items within the first region of the virtual meeting UI.

In an aspect, the method includes automatically adjusting an aspect ratio of the first region of the virtual meeting UI to match an aspect ratio of the first media item. In an aspect, causing the first media item to be presented within the first region of the virtual meeting UI includes causing the first media item to be presented within the first region of virtual meeting UI together with the visual item corresponding to the video stream generated by the first client device or in place of the visual item corresponding to the video stream generated by the first client device.

Another aspect of the disclosure provides a system that includes a memory device. The system also includes a processing device coupled to the memory device. The processing device to perform operations. The operations include providing a virtual meeting user interface (UI) including multiple regions each presenting a visual item corresponding to a video stream generated by one of multiple client devices of multiple participants of a virtual meeting. The method includes receiving a first request from a first participant of the multiple participants of the virtual meeting to share a first media item with other participants of the virtual meeting. The method includes identifying, in a virtual meeting UI, a first region presenting a visual item corresponding to a video stream generated by a first client device of the first participant. The method includes causing the first media item to be presented within the first region of the virtual meeting UI.

Another aspect of the disclosure provides a non-transitory computer-readable storage medium including instructions that, when executed by a processing device, cause the processing device to perform operations. The operations include providing a virtual meeting user interface (UI) including multiple regions each presenting a visual item corresponding to a video stream generated by one of multiple client devices of multiple participants of a virtual meeting. The method includes receiving a first request from a first participant of the multiple participants of the virtual meeting to share a first media item with other participants of the virtual meeting. The method includes identifying, in a virtual meeting UI, a first region presenting a visual item corresponding to a video stream generated by a first client device of the first participant. The method includes causing the first media item to be presented within the first region of the virtual meeting UI.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system architecture, in accordance with at least one embodiment of the present disclosure.

FIG. 2A illustrates an example user interface (UI) of a virtual meeting, in accordance with at least one embodiment of the present disclosure.

FIG. 2B illustrates an example user request to display a media item within a UI of a virtual meeting, in accordance with at least one embodiment of the present disclosure.

FIG. 2C illustrates displaying a media item within a UI of a virtual meeting, in accordance with at least one embodiment of the present disclosure.

FIG. 2D illustrates displaying a video item within a UI of a virtual meeting, in accordance with at least one embodiment of the present disclosure.

FIG. 3 depicts a flow diagram of a method for sharing media items in a virtual meeting, in accordance with at least one embodiment of the present disclosure.

FIG. 4 depicts a block diagram illustrating an example computer system, in accordance with implementations of the present disclosure.

### DETAILED DESCRIPTION

Aspects of the present disclosure relate to sharing media items in a virtual meeting. A platform can enable users to connect with other users through a video or audio-based virtual meeting (e.g., a conference call, a video conference, etc.). The platform can provide tools that allow client devices associated with users (referred to herein as participants) to share audio data and/or video data with client devices associated with other participants (e.g., over a network). Virtual meetings can facilitate real-time interactions, allowing participants to engage in discussion, share presentations, and collaborate remotely. Some participants of a virtual meeting may wish to share media content (e.g., images, videos, audio, presentations, etc.) with other participants of the virtual meeting. However, existing virtual meeting platforms lack robust features for seamlessly sharing diverse media content such as images and videos.

Some virtual meeting platforms offer a screen share feature that participants can use to share media with other participants of a virtual meeting. For example, during a virtual meeting, a participant can engage with a screen sharing option on the virtual meeting user interface (UI) to open a screen sharing options menu. The participant can choose whether to share their entire screen of a specific application or window where the photo is open with other participants of the virtual meeting. However, this approach to sharing media content within a virtual meeting has several disadvantages. For example, when a participant begins screensharing, the screenshare often replaces an ongoing presentation, disrupting the focus of the meeting. Additionally, when a participant initiates screen sharing, conventional virtual meeting platforms often transition the virtual meeting UI to a layout in which the shared content takes precedence over other visual items such as video streams and presentations being presented within the UI. The shared content can become the focal point for participants, often expanding to fill in most of the virtual meeting UI. Video streams of other participants are minimized, shown in a grid format, and/or moved to a different section of the UI. In this manner, content shared via the share screen functionality can compete with the presentation of the participants' video streams within the virtual meeting UI.

In some instances, conventional implementations of a virtual meeting platform can provide other methods for sharing media content. These methods can involve cumbersome processes, such as uploading a file attachment to a separate cloud storage platform, copying and pasting a link, or the like. These methods often disrupt the flow of the virtual meeting, leading to inefficiencies and decreased productivity. Participants can find it technically difficult to navigate many user interaction steps to share media content in a virtual meeting environment. Additionally, accessing media content to share in this manner can present several security risks. For example, file attachments shared in a virtual meeting can contain malicious software which can infect a user device upon opening the file attachment and malicious links shared in a virtual meeting can redirect a client device to a compromised website using a deceptive uniform resource locator (URL).

Moreover, participants can be distracted by attempting to figure out how to share media content with other participants of a virtual meeting and therefore may not be fully engaged in the meeting discussion. As a result, discussion topics can be covered again (sometimes multiple times) during the meeting, which can increase the overall duration of the virtual meeting. Computing resources (e.g., processing cycles, memory space, etc.) are consumed by the platform and/or client devices connected to the platform to facilitate the increased duration of the virtual meeting. Such resources are unavailable to other processes (e.g., of the platform, of the client devices, etc.), which can increase an overall latency and decrease an overall efficiency of the system.

Implementations of the present disclosure address the above and other deficiencies by providing systems and methods to share media items in a virtual meeting. Media items can include, but are not limited to, textual content, audio, images, videos, mixed media, and the like. A participant of a virtual meeting can share a media item with other participants of the virtual meeting by dragging and dropping the media item (e.g., a video item, an image, etc.) into the virtual meeting UI. The media content can temporarily replace a visual representation of the participant's video stream in the virtual meeting UI. Other participants can see the media item in a region of the virtual meeting UI where the participant's video stream was previously presented. Any ongoing presentation or screen share can continue uninterrupted as the shared media content is not competing to be displayed in the same region as content shared via screensharing. In some instances, the virtual meeting UI can indicate that the shared media content is shared media content and not the participant's video stream. In some instances, the participant can drag multiple images into the virtual meeting UI at the same time. This can cause the virtual meeting UI to display the first shared photo with next/previous buttons that allow the sharing participant to switch which photo is currently being displayed to participants of the virtual meeting.

Aspects of the present disclosure provide technical advantages over previous solutions. Aspects of the present disclosure can provide a seamless method that allows participants of a virtual meeting to share media items in a virtual meeting. Aspects of the present disclosure allow participants to display media items in a region of the virtual meeting UI in place of or in addition to the presentation of their video stream rather than using screen sharing functionality of the virtual meeting platform to share media items. As such, participants can quickly share media content and be fully engaged in the virtual meeting discussion without distractions caused by switching to screen share mode or using other conventional methods to share media items, which can reduce the overall duration of the virtual meeting. As the duration of the virtual meeting is reduced, the amount of computing resources consumed by the platform and/or the client devices connected to the platform is also reduced. Such resources are therefore available to other processes (e.g., at the platform and/or the client devices), which can decrease an overall latency and increase an overall efficiency of the system.

Additionally, aspects and implementations of the present disclosure can mitigate security risks associated with sharing media content. For example, the media item can be sent as a media feed to the virtual meeting platform and not as a file attachment. The media feed can be streamed directly to client devices of participants of the virtual meeting and does not require the participant to download and save a file locally to view the shared media item. This minimizes the risk of a participant of a virtual meeting downloading malware or viruses that could be embedded within file attachments or links shared within a virtual meeting.

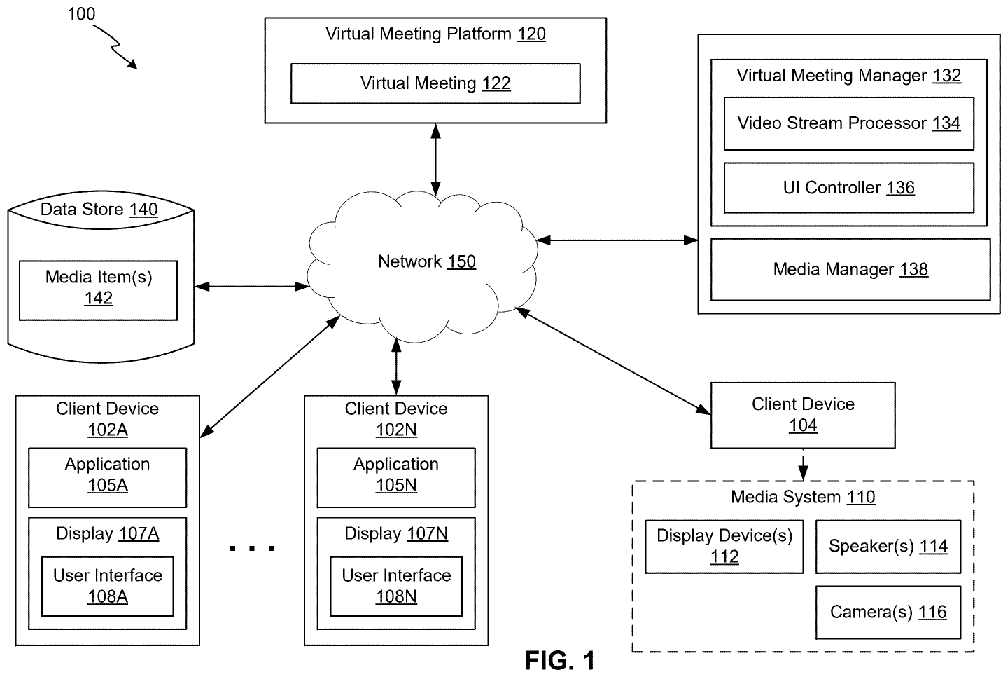

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 can include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UI 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-107N by the client applications 105A-N executing on the operating systems of the client devices 102A-N, 104. In some implementations, the virtual meeting manager 132 determines visual items for presentation in the UIs 108A-N during a virtual meeting 122. A visual item can refer to a UI element that occupies a particular region in the UI 108A-N and is dedicated to presenting a video stream from a respective client device 102A-N, 104. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 can include a software application (or a subset thereof) that performs certain virtual meeting functionality for the virtual meeting manager 132. The video stream processor 134 can be configured to receive video streams from one or more of the client devices 102A-N, 104. The video stream processor 134 can be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the virtual meeting 122 further includes, for each participant of the one or more participants, first audio data associated with an audio stream produced by a client device 102A-N, 104 of a respective participant. The video stream processor 134 can receive audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122. The UI can include multiple regions. Each region can display a video stream pertaining to one or more participants of the virtual meeting 122. The UI controller 136 can control which video stream is to be displayed by providing a command to one or more client devices 102A-N, 104 that indicates which video stream is to be displayed in which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

In one or more implementations, the virtual meeting manager 132 includes media manager 138. Media manager 138 can include a combination of software and hardware components that provides certain virtual meeting functionality for the virtual meeting manager 132. Media information manager 138 can receive a request from a participant of virtual meeting 122 to display a media item (e.g., media item 142) within a UI of virtual meeting 122. Media manager 138 can control which media is to be displayed within the UI of the virtual meeting 122 by receiving a command from one or more client devices 102A-N, 104 that indicates a media item 142 that is to be displayed in a region of the UI in place of a visual item corresponding to the participant's video stream. For example, in response to being notified of the received media item 142 for presentation in the UI 108A-N, media manager 138 can transmit a command causing the received media item to be displayed in a region of the UI corresponding to the visual item of the requesting participant's video stream.

In some embodiments, media manager 138 can cause the received media item 142 to be displayed within the region of UI 108A-N in the place of the visual item of the requesting participant's video stream. In some embodiments, media item manager 138 can cause the received media item 142 to be displayed within the region of the UI 108A-N together with the visual item corresponding to the participant's video stream. For example, media manager 138 can cause the received media item 142 to be displayed at a first portion of the region of UI 108A-N and the cause the visual item corresponding to the participant's video stream to be displayed at a second portion of the region of UI 108A-N. In another example, media manager 138 can cause the received media item 142 to be displayed within the entirety of the region of UI 108A-N and composite the visual item corresponding to the participant's video stream on top of media item 142. Accordingly, media item 142 can be displayed in place of or in addition to visual item corresponding to the participant's video stream within the designated region of UI 108A-N.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to the one or more client devices 102A-N, the client device 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to the virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107A-N of a client device 102A-N or a UI (e.g., a UI of the UIs 108A-N), one or more features of the application 105A-N for users to access the virtual meeting platform 120. For example, a user of a first client device 102A can join and participate in the virtual meeting 122 via a UI 108A presented on the display device 107A by the application 105A. The user can present a document to participants of the virtual meeting 122 using the UI 108A. Each of the UIs 108A-N can include multiple regions to present visual items corresponding to video streams of the client devices 102A-N provided to the server 130 for the virtual meeting 122.

In one or more implementations, one or more components of the virtual meeting manager 132 are part of a client device 102A-N and/or client device 104. For example, the application 105A-N can include media manager 138, which can cause media item(s) 142 to be displayed within a UI of virtual meeting 122, and perform other functionality. In some implementations, the application 105A of a first client device 102A sends the video stream produced by the client device 102A to the other client devices 102B-N, 104 and receives the video streams from the other client devices 102B-N, 104, and the applications 105A-105N can generate their respective virtual meeting UIs 108A-108N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users. In some implementations, the data store stores media item 142. Media items 142 can include, but is not limited to, images and/or video items received from client devices 102A-N for presentation within a UI of virtual meeting 122.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

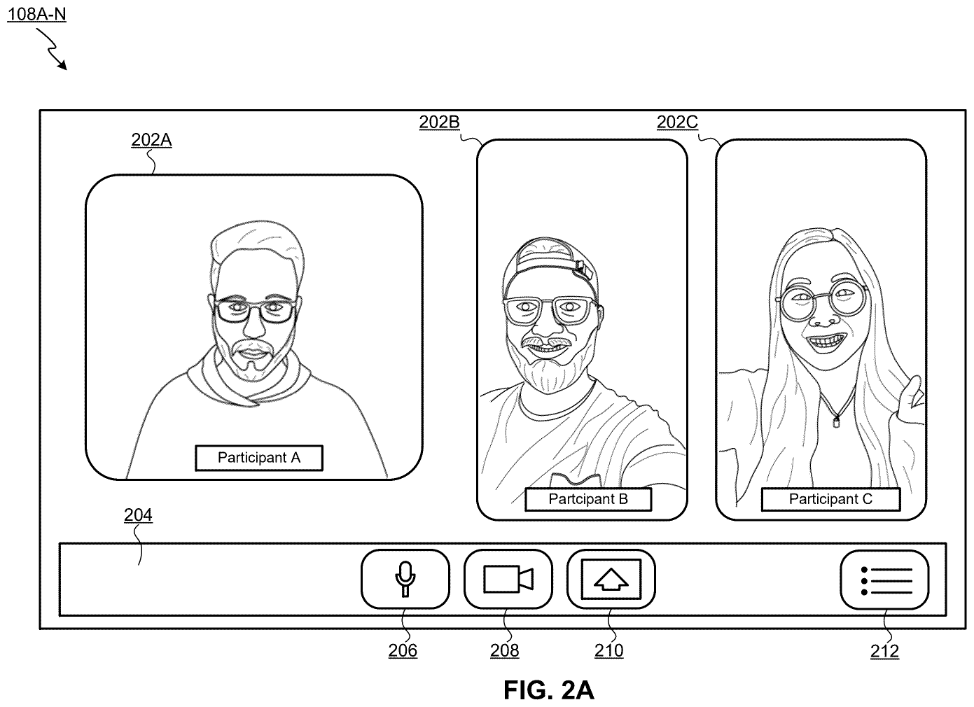

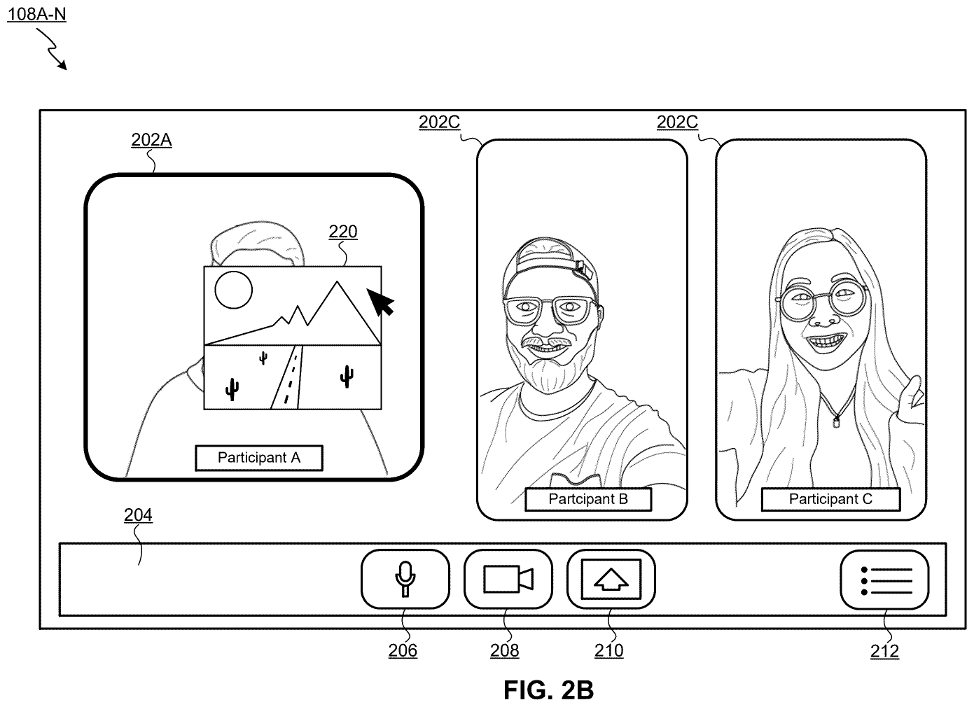

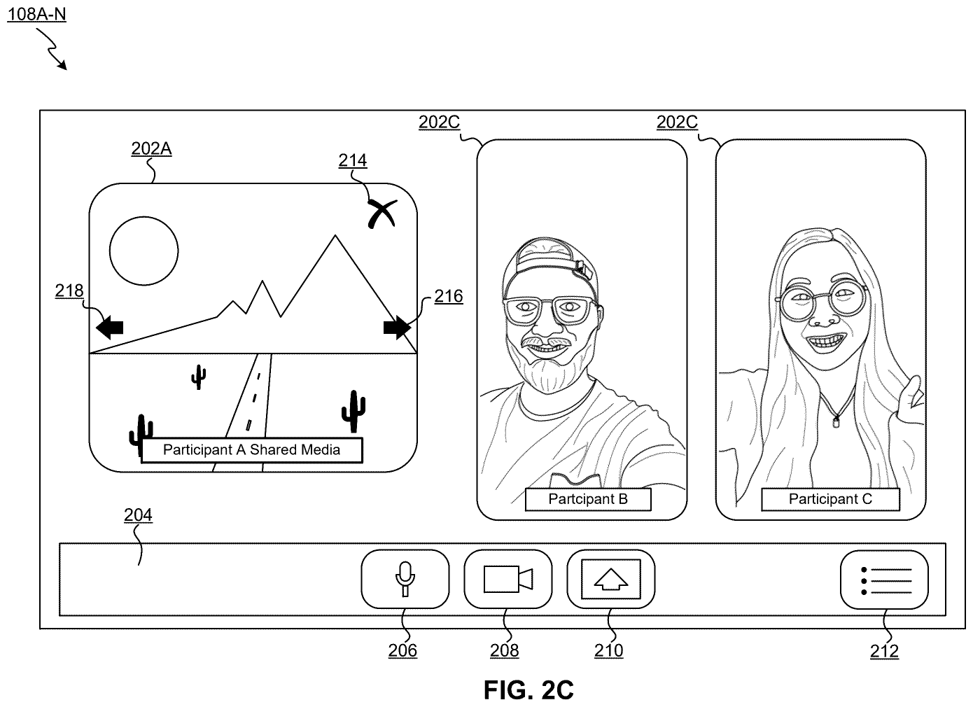

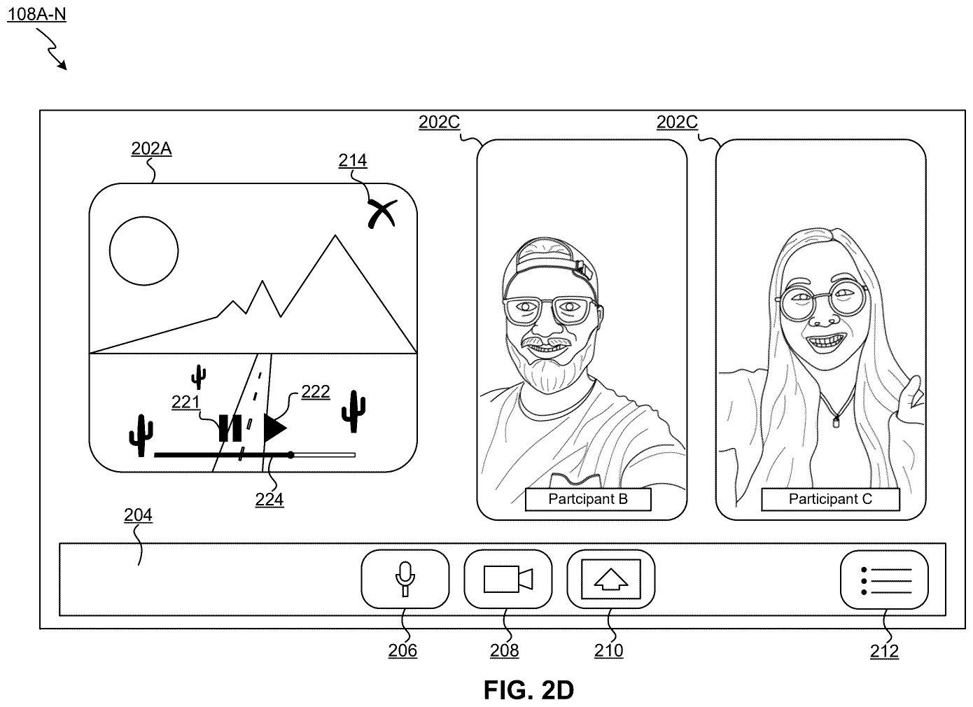

FIG. 2A illustrates an example user interface (UI) 108A-N for a virtual meeting 122, in accordance with some embodiments of the present disclosure. The UI 108A-N can be provided by one or more processing devices of a server, such as server 130 of FIG. 1, or client device 102A-N. In some embodiments, the UI 108A-N can be provided by a virtual meeting manager, such as virtual meeting manager 132 of FIG. 1, for presentation at a client device (e.g., client devices 102A-N of FIG. 1). In some implementations, the virtual meeting 122 between multiple participants can be managed by a virtual meeting platform, such as virtual meeting platform 120 of FIG. 1. As described with respect to FIG. 1, virtual meeting manager 132 can enable participants (e.g., participants A-C seen in FIG. 2A) to join and participate in the virtual meeting 122.

As illustrated in FIG. 2A, UI 108A-N can include one or more visual items. A visual item can refer to a UI element that occupies a particular region in the UI. In some instances, and by way of a non-limiting example, a visual item can be dedicated to presenting a video stream from a respective client device (e.g., a client device from client devices 102A-N in FIG. 1) to other client devices (e.g., a different client device from client devices 102A-N in FIG. 1). Such a video stream can depict, for example, a user of the respective client device while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, and the like.

In some embodiments, and dependent on the type and purpose of the virtual meeting, multiple visual items and respective regions in the UI 108A-N can be incorporated. As illustrated, UI 108A-N can include multiple regions 202A-C that can include different visual items of the virtual meeting 122, such as video streams provided by respective client devices 102A-N. For example, region 202A can include a visual item of a visual stream of Participant A provided by a client device 102A, region 202B can include a visual item of a visual stream of Participant B provided by a client device 102B, and so forth. Although FIG. 2A depicts UI 108A-N as having three regions, one of ordinary skill in the art, having the benefit of this disclosure, will understand that more (or fewer) visual items and/or associated regions can be included in UI 200 for presentation to a user, as can be reasonable to be perceived and understood by the human eye.

In some embodiments, the virtual meeting UI 108A-N can include a toolbar 204 that includes one or more UI elements configured to perform virtual meeting operations. For example, as seen in FIG. 2A, the toolbar 204 includes an audio control button 206 used to mute and unmute a participant's audio stream, a camera control button 208 used to cease to display and display a participant's video stream, and a screen share button 210 used to share a participant's client device's 102A-N screen with other participants of the virtual meeting 122. In some implementations, the toolbar 204 can include one or more buttons that, responsive to a participant interacting with the buttons, cause the media manager 138 to use an AI model, such as AI model included in AI subsystem 139, to generate one or more information items about another participant of the virtual meeting. The UI 108A-N may display the one or more information items.

In some implementations, the UI 108A-N can also include an options region 212 for providing selectable options to adjust display settings (e.g., a size of each region 202A-C, a number of regions, a selection of a video stream, etc.), invite additional users to participate, etc. In some implementations, the UI 108A-N can include a UI element (e.g., an icon) (not illustrated in FIG. 2A) that corresponds to a self-view indicator, which may indicate to a participant if the participant's video stream is displayed in a region in the UI.

In some embodiments, the user can interact with the UI 108A-N to cause a modification of a size or a position of video streams displayed within the UI 108A-N. For example, the user can use an input device (e.g., a keyboard, a touch screen etc.) or a cursor device (e.g., a mouse) associated with the client device to cause a modification of the size or the position of the video streams displayed within the UI 108A-N. One of ordinary skill in the art, having the benefit of this disclosure, will be able to design and implement a variety of ways that a user can modify the UI 108A-N to their liking, while still achieving similar results as the UI 108A-N presented.

FIG. 2B illustrates an example user request to display a media item within a UI 108A-N of a virtual meeting 122, in accordance with at least one embodiment of the present disclosure. The UI 108A-N may be provided by one or more processing devices of a server, such as server 130 of FIG. 1, or client device 102A-N. In some embodiments, the UI 108A-N may be provided by a virtual meeting manager, such as virtual meeting manager 132 of FIG. 1, for presentation at a client device (e.g., client devices 102A-N of FIG. 1).

As illustrated, a participant can initiate a request to share a media item 220 by interacting with the UI 108A-N. In some embodiments, the request to share media item 220 with other participants (e.g., participant B, participant C, etc.) is received by media manager 138 in response to detecting a user input corresponding to the first participant moving the media item 220 from a position outside of UI 108A-N to a position within UI 108A-N. For example, participant A can locate an image file corresponding to media item 142 from outside UI 108A-N, such as from a file explore window or an image viewer application of a client device 102. Participant A can click (e.g., using a stylus, a mouse, etc.) on the image file and drag the image file into a designated sharing region within virtual meeting UI 108A-N. The sharing region can correspond to region 202A or any other region within virtual meeting UI 108A-N. Participant A can drop the image file into the sharing region of virtual meeting UI 108A-N to cause media manager to display media item 220 within region 202A, as illustrated below with respect to FIG. 2C.

In some embodiments, different methods of sharing media item 142 can be initiated based on the position within the UI 108A-N that the dropped onto. For example, Participant A can drag and drop media item 142 into a position within region 202A, causing media item 142 to be displayed within region 202A. Alternatively, Participant A can drag and drop media item 142 into a position within UI 108A-N that is not included in region 202A, invoking screensharing of media item 142.

It appreciated that the request to display media item 220 within region 202A of UI 108A-N can be initiated by other mechanisms without deviating from the scope of the present disclosure. For example, the request to display media item 220 within region 202A can be initiated in response to a user interaction with one or more selectable options provided within options region 212.

FIG. 2C illustrates displaying a media item 220 within a UI 108A-N of a virtual meeting 122, in accordance with at least one embodiment of the present disclosure. The UI 108A-N can be provided by one or more processing devices of a server, such as server 130 of FIG. 1, or client device 102A-N. In some embodiments, the UI 108A-N can be provided by a virtual meeting manager, such as virtual meeting manager 132 of FIG. 1, for presentation at a client device (e.g., client devices 102A-N of FIG. 1). Media item 220 can be provided by a client device 102A-N of a participant of virtual meeting 122.

In some embodiments, media item 220 can be displayed within region 202A in place of a visual item corresponding to the video stream of Participant A generated by client device 102, as illustrated. A UI indicator can be displayed within region 202A, indicating that the media item 220 displayed within region 202A is shared media content, and not a participant video stream. In some embodiments, media item 202 can be displayed within region 202A of virtual meeting UI 108A-N together with a visual item corresponding to the video stream of Participant A generated by client device 102A-N. For example, region 202A can include a thumbnail region (not illustrated). The thumbnail region can be a region to display a scaled-down version of Participant A's video stream or screen share. Media manager 138 can cause a visual item corresponding to a visual stream of Participant A to be displayed within the thumbnail region composited on top of the media item 220 displayed within region 202A. In some embodiments, media manager 138 can automatically adjust an aspect ratio of region 202A to match the aspect ratio of media item 220. In some embodiments, media manager 138 can apply a letterbox or pillarbox effect to media item 220 to ensure it can fit within the aspect ratio of region 202A.

In some embodiments, a participant can initiate a request to share multiple media items. For example, Participant A can share multiple media items by moving multiple selected media items from a position outside of UI 108A-N to a position within UI 108A-N, such as a position within region 202A. In some embodiments, the participant can alternate which media items of the multiple shared media items is displayed within region 202A by interacting with one or more UI elements. For example, as seen in FIG. 2C, region 202A can include a next button 216 used to display a next photo in a set of shared photos and a previous button 218 used to display a previous photo in a set of shared photos. In some embodiments, region 202A can include a UI element 214 used to stop displaying media item 220 within region 202A and revert to displaying a video stream generated by a client device of a Participant A.

FIG. 2D illustrates displaying a video item within a UI 108A-N of a virtual meeting 122, in accordance with at least one embodiment of the present disclosure. The UI 108A-N can be provided by one or more processing devices of a server, such as server 130 of FIG. 1, or client device 102A-N. In some embodiments, the UI 108A-N can be provided by a virtual meeting manager, such as virtual meeting manager 132 of FIG. 1, for presentation at a client device (e.g., client devices 102A-N of FIG. 1). The video item can be provided by a client device 102A-N of a participant of virtual meeting 122.

A video item can be displayed within region 202A in place of a visual item corresponding to the video stream of Participant A generated by client device 102, as illustrated. In some embodiments, the region 108A-N can include one or more playback control elements configured to control playback of audio and/or video associated with the video item on client device 102A-N. For example, as seen in FIG. 2D, the playback controls include a play control button 222 for initiating playback of the video item. When engaged with by the sharing participant (e.g., Participant A), the video item can begin or resume playing. The playback controls include a pause button 221 for temporality halting playback of the video item. When engaged with by the sharing participant, the video item can pause the current position of the video item, allowing playback to be resumed from the same point. In some embodiments, the playback controls can include a seek control element 224 for directly navigating to a specific position within the video item. The seek control element 224 can be implemented as a slider as illustrated or as an input field in which the sharing participant can specify a time or position marker. In some embodiments, the playback controls can include one or more controls not illustrated with respect to FIG. 2D such as an audio control, a fast-forward control, a rewind control, and the like.

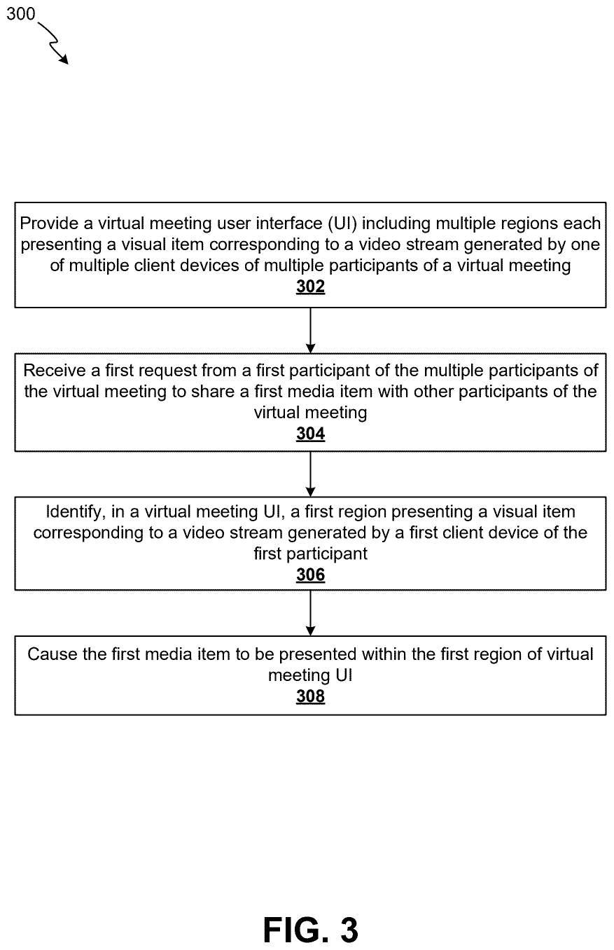

FIG. 3 depicts a flow diagram of a method 300 for sharing media items in a virtual meeting, in accordance with at least one embodiment of the present disclosure. Method 300 can be performed by processing logic that can include hardware (circuitry, dedicated logic, etc.), software (e.g., instructions run on a processing device), firmware, and/or a combination thereof. In one implementation, some or all the operations of method 300 can be performed by one or more components of system 100 of FIG. 1 (e.g., server 130, client device 102A-N, virtual meeting manager 132, media manager 138, etc.).

For simplicity of explanation, the method 300 of this disclosure is depicted and described as a series of acts. However, acts in accordance with this disclosure may occur in various orders and/or concurrently, and with other acts not presented and described herein. Furthermore, not all illustrated acts may be required to implement the method 300 in accordance with the disclosed subject matter. In addition, those skilled in the art will understand and appreciate that the method 300 could alternatively be represented as a series of interrelated states via a state diagram or events. Additionally, it should be appreciated that the method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 302 of method 300, processing logic provides a virtual meeting user interface (UI) including multiple regions each presenting a visual item corresponding to a video stream generated by one of multiple client devices of multiple participants of a virtual meeting.

At block 304 of method 300, processing logic receives a first request from a first participant of the multiple participants of the virtual meeting to share a first media item with other participants of the virtual meeting. In some embodiments, processing logic receives the first request to share the first media item in response to detecting a user input corresponding to the first participant moving the first media item from a first position that is outside of the virtual meeting UI to a second position within the virtual meeting UI.

At block 306 of method 300, processing logic Identifies, in a virtual meeting UI, a first region presenting a visual item corresponding to a video stream generated by a first client device of the first participant.

At block 308 of method 300, processing logic causes the first media item to be presented within the first region of the virtual meeting UI. In some embodiments, the processing logic can automatically adjust an aspect ratio of the first region of the virtual meeting UI to match an aspect ratio of the first media item. In some embodiments, cause the media item to be presented within the first region of the virtual meeting, the processing logic can cause the first media item to be presented within the first region of virtual meeting UI together with the visual item corresponding to the video stream generated by the first client device or in place of the visual item corresponding to the video stream generated by the first client device.

In some embodiments, the first media item is a video item, and the processing logic can provide, for presentation within the first region of the virtual meeting UI, one or more playback controls usable to interact with the video item.

In some embodiments, processing logic can provide, for presentation within the first region of the virtual meeting UI, a UI indicator indicating that the first media item displayed within the first region of the virtual meeting UI is shared media content associated with the first participant.

In some embodiments, processing logic can receive a second request from the first participant to share a second media item with the other participants of the virtual meeting. Processing logic can provide, for presentation within the first region of virtual meeting UI, a second media item in place of the first media item. Processing logic can provide one or more UI elements for display within the virtual meeting UI. The one or more UI elements are useable by the first participant to switch between displaying the first and the second media items within the first region of the virtual meeting UI.

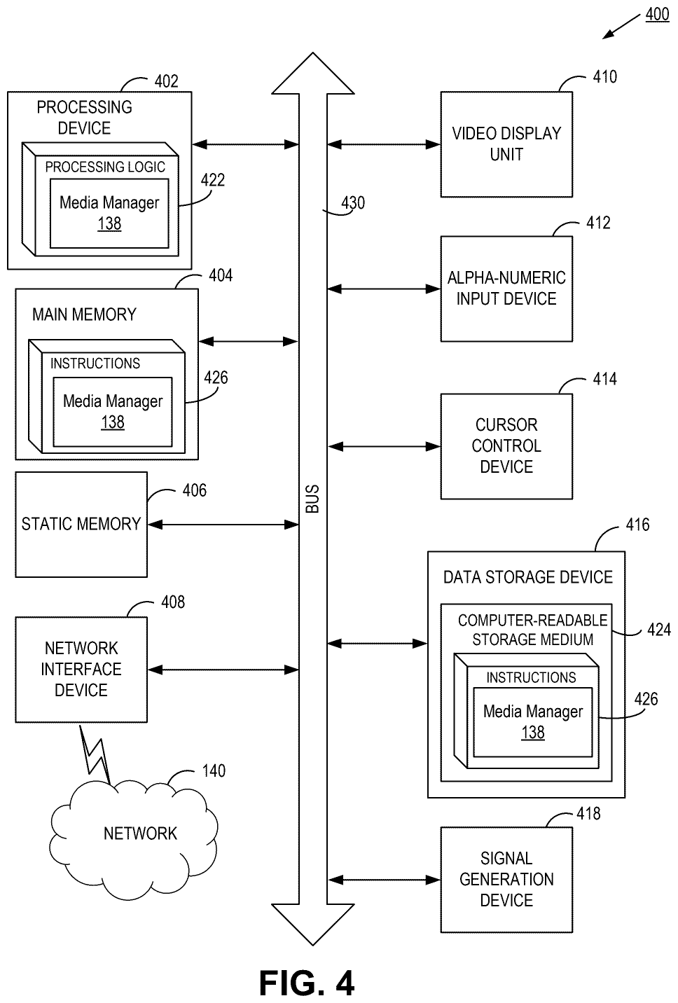

FIG. 4 is a block diagram illustrating an example computer system 400, in accordance with implementations of the present disclosure. The computer system 400 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random-access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 430.

The processing device 402 represents one or more general-purpose processing devices such as a microprocessor, central processing unit, or the like. More particularly, the processing device 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 can also be one or more special-purpose processing devices such as an application specific integrated circuit (ASIC), a field programmable gate array (FPGA), a digital signal processor (DSP), network processor, or the like. The processing device 402 is configured to execute the processing logic 422 for performing the operations discussed herein (e.g., the operations of the media manager 138).

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker).

The data storage device 416 can include a non-transitory machine-readable storage medium 424 (sometimes referred to as a “computer-readable storage medium”) on which is stored one or more sets of instructions 426 (e.g., the instructions to carry out one or more operations of the absent user manager 138) embodying any one or more of the methodologies or functions described herein. The instructions can also reside, completely or at least partially, within the main memory 404 and/or within the processing device 402 during execution thereof by the computer system 400, the main memory 404 and the processing device 402 also constituting machine-readable storage media. The instructions can further be transmitted or received over the network 150 via the network interface device 408.

In one implementation, the instructions 426 include instructions for determining visual items for presentation in a user interface of a virtual meeting. While the computer-readable storage medium computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
providing a virtual meeting user interface (UI) comprising a plurality of regions each presenting a visual item corresponding to a video stream generated by one of a plurality of client devices of a plurality of participants of a virtual meeting;
receiving a first request from a first participant of the plurality of participants of the virtual meeting to share a first media item with other participants of the virtual meeting;
identifying, in a virtual meeting UI, a first region presenting a visual item corresponding to a video stream generated by a first client device of the first participant; and
causing the first media item to be presented within the first region of the virtual meeting UI.

2. The method of claim 1, wherein the first request to share the first media item is received in response to detecting a user input corresponding to the first participant moving the first media item from a first position that is outside of the virtual meeting UI to a second position within the virtual meeting UI.

3. The method a claim 1, further comprising:
providing, for presentation within the first region of the virtual meeting UI, a UI indicator indicating that the first media item displayed within the first region of the virtual meeting UI is shared media content associated with the first participant.

4. The method of claim 1, wherein the first media item comprises a video item, and the method further comprises providing, for presentation within the first region of the virtual meeting UI, one or more playback controls usable to interact with the video item.

5. The method of claim 1, further comprising:
receiving a second request from the first participant to share a second media item with other participants of the virtual meeting;
providing, for presentation within the first region of virtual meeting UI, a second media item in place of the first media item; and
providing one or more UI elements for display within the virtual meeting UI, wherein the one or more UI elements are useable by the first participant to switch between displaying the first and the second media items within the first region of the virtual meeting UI.

6. The method of claim 1, further comprising:
automatically adjusting an aspect ratio of the first region of the virtual meeting UI to match an aspect ratio of the first media item.

7. The method of claim 1, wherein causing the first media item to be presented within the first region of the virtual meeting UI comprises causing the first media item to be presented within the first region of virtual meeting UI together with the visual item corresponding to the video stream generated by the first client device or in place of the visual item corresponding to the video stream generated by the first client device.

8. A system comprising:
a memory device; and
a processing device coupled to the memory device, the processing device to perform operations comprising:
providing a virtual meeting user interface (UI) comprising a plurality of regions each presenting a visual item corresponding to a video stream generated by one of a plurality of client devices of a plurality of participants of a virtual meeting;
receiving a first request from a first participant of the plurality of participants of the virtual meeting to share a first media item with other participants of the virtual meeting;
identifying, in a virtual meeting UI, a first region presenting a visual item corresponding to a video stream generated by a first client device of the first participant; and
causing the first media item to be presented within the first region of the virtual meeting UI.

9. The system of claim 8, wherein the first request to share the first media item is received in response to detecting a user input corresponding to the first participant moving the first media item from a first position that is outside of the virtual meeting UI to a second position within the virtual meeting UI.

10. The system a claim 8, further comprising:
providing, for presentation within the first region of the virtual meeting UI, a UI indicator indicating that the first media item displayed within the first region of the virtual meeting UI is shared media content associated with the first participant.

11. The system of claim 8, wherein the first media item comprises a video item, and further comprising providing, for presentation within the first region of the virtual meeting UI, one or more playback controls usable to interact with the video item.

12. The system of claim 8, further comprising:
receiving a second request from the first participant to share a second media item with other participants of the virtual meeting;
providing, for presentation within the first region of virtual meeting UI, a second media item in place of the first media item; and
providing one or more UI elements for display within the virtual meeting UI, wherein the one or more UI elements are useable by the first participant to switch between displaying the first and the second media items within the first region of the virtual meeting UI.

13. The system of claim 8, further comprising:
automatically adjusting an aspect ratio of the first region of the virtual meeting UI to match an aspect ratio of the first media item.

14. The system of claim 8, wherein causing the first media item to be presented within the first region of the virtual meeting UI comprises causing the first media item to be presented within the first region of virtual meeting UI together with the visual item corresponding to the video stream generated by the first client device or in place of the visual item corresponding to the video stream generated by the first client device.

15. A non-transitory computer-readable storage medium comprising instructions that, when executed by a processing device, cause the processing device to perform operations comprising:
providing a virtual meeting user interface (UI) comprising a plurality of regions each presenting a visual item corresponding to a video stream generated by one of a plurality of client devices of a plurality of participants of a virtual meeting;
receiving a first request from a first participant of the plurality of participants of the virtual meeting to share a first media item with other participants of the virtual meeting;
identifying, in a virtual meeting UI, a first region presenting a visual item corresponding to a video stream generated by a first client device of the first participant; and
causing the first media item to be presented within the first region of the virtual meeting UI.

16. The non-transitory computer-readable storage medium of claim 15, wherein the first request to share the first media item is received in response to detecting a user input corresponding to the first participant moving the first media item from a first position that is outside of the virtual meeting UI to a second position within the virtual meeting UI.

17. The non-transitory computer-readable storage medium a claim 15, further comprising:
providing, for presentation within the first region of the virtual meeting UI, a UI indicator indicating that the first media item displayed within the first region of the virtual meeting UI is shared media content associated with the first participant.

18. The non-transitory computer-readable storage medium of claim 15, wherein the first media item comprises a video item, and further comprising providing, for presentation within the first region of the virtual meeting UI, one or more playback controls usable to interact with the video item.

19. The non-transitory computer-readable storage medium of claim 15, further comprising:
receiving a second request from the first participant to share a second media item with the other participants of the virtual meeting;
providing, for presentation within the first region of virtual meeting UI, a second media item in place of the first media item; and
providing one or more UI elements for display within the virtual meeting UI, wherein the one or more UI elements are useable by the first participant to switch between displaying the first and the second media items within the first region of the virtual meeting UI.

20. The non-transitory computer-readable storage medium of claim 15, further comprising:
automatically adjusting an aspect ratio of the first region of the virtual meeting UI to match an aspect ratio of the first media item.
